(19) United States
(12) Patent Application Publication
(10) Pub. No.: US 2015/0044480 A1
(43) Pub. Date: Feb. 12, 2015

(54) POLYURETHANE IMPREGNATED PAPER LAMINATE AND METHOD THEREFOR

(71) Applicant: MOULURES TRANSFORM INC., Alma (CA)

(72) Inventor: Alain GIRARD, Alma (CA)

(21) Appl. No.: 14/453,934

(22) Filed: Aug. 7, 2014

Related U.S. Application Data
(60) Provisional application No. 61/863,562, filed on Aug. 8, 2013.

(51) Int. Cl. D21H 27/22; B05D 3/06; B05D 3/12; D21H 19/62; B05D 7/24; B29C 59/02; D21H 19/82; D21H 19/24; B05D 1/36; B05D 7/00

(52) U.S. Cl. CPC D21H 27/22; B05D 1/36; B05D 3/067; B05D 3/12; B05D 7/58; B05D 7/24; B29C 59/02; D21H 19/82; D21H 19/24; D21H 19/62; B29K 2075/00
USPC 428/423.3; 427/411; 427/558; 264/134

(57) ABSTRACT

A method for producing a polyurethane-impregnated paper laminate comprising the steps of impregnating paper with a mixture of a polyurethane-based liquid material and a catalyst, maintaining the paper into the mixture for a predetermined duration for polymerization thereof and coating the impregnated paper with a sheet of solid polyurethane-based material and a finishing top coat.

### CROSS-REFERENCE TO RELATED APPLICATIONS

This application claims the benefits of U.S. provisional patent application No. 61/863,562 filed on Aug. 8, 2013, which is herein incorporated by reference.

### TECHNICAL FIELD

The present disclosure relates to an impregnated paper laminate, and is more particularly concerned with polyurethane impregnation of paper for use in laminates, for example in the application of cabinets such as kitchen cabinets, and method of producing the polyurethane impregnated paper laminate.

### BACKGROUND

It is well known today to apply a hot coating of polyurethane directly onto a hard surface using a polyethylene based adhesive and embossed and/or dyed to provide a nice surface finish thereof, such as for melamine finish type planks or the like, made on production lines. Such hot coatings cannot be easily applied on-site on curved surfaces such as moldings, kitchen door panels and the like since they are brittle and would easily break. Similarly, when pre-applied onto a flexible paper material to form a paper laminate, such laminate will tend to delaminate after application onto a curved surface.

Accordingly there is a need for an improved flexible impregnated paper laminate, and a method of production thereof.

### SUMMARY

It is therefore a general object of the present disclosure to provide a method for producing an improved polyurethane impregnated paper laminate.

An advantage of the present disclosure is that the method produces a flexible paper laminate that can be easily applied as a surface finish on curved surfaces, without delamination and/or breaking thereof.

Another advantage of the present disclosure is that the method enables the flexible polyurethane impregnated paper laminate to be dyed and/or embossed to provide a wide variety of surface finishes.

According to a first aspect of the present disclosure, there is provided a method for producing a polyurethane-impregnated paper laminate, the method comprising the steps of:
a) impregnating paper with a mixture of a polyurethane-based liquid material and a catalyst;
b) maintaining the paper into said mixture for a first predetermined duration for polymerisation thereof; and
c) hot coating the impregnated paper with a polyurethane-based material and applying a finishing top coat.

Conveniently, the method further includes a step d) of curing of the hot coated polyurethane impregnated paper laminate for a second predetermined duration, preferably within a humidity controlled environment.

According to a second aspect of the present disclosure, there is provided polyurethane impregnated paper laminate comprising a paper impregnated with a mixture of a polyurethane-based liquid material and a catalyst, a sheet of solid polyurethane-based material and a finishing top coat.

Other objects and advantages of the present disclosure will become apparent from a careful reading of the detailed description provided herein.

### BRIEF DESCRIPTION OF THE FIGURES

Embodiments of the disclosure will be described by way of examples only with reference to the accompanying drawings, in which:

FIG. 1 is a flow diagram of the polyurethane impregnated paper laminate production process in accordance with an illustrative embodiment of the present disclosure; and

FIGS. 2a and 2b are cross-sectional schematic representations (i.e. not to scale) of polyurethane-impregnated paper laminates produced by the process of FIG. 1, without (FIG. 2a) and with (FIG. 2b) embossing.

Similar references used in different Figures denote similar components.

### DETAILED DESCRIPTION

Generally stated, the non-limitative illustrative embodiment of the present disclosure provides a substantially flexible polyurethane impregnated paper laminate such as for use for wood or foil plating or veneering, as well as a method of producing such paper laminate.

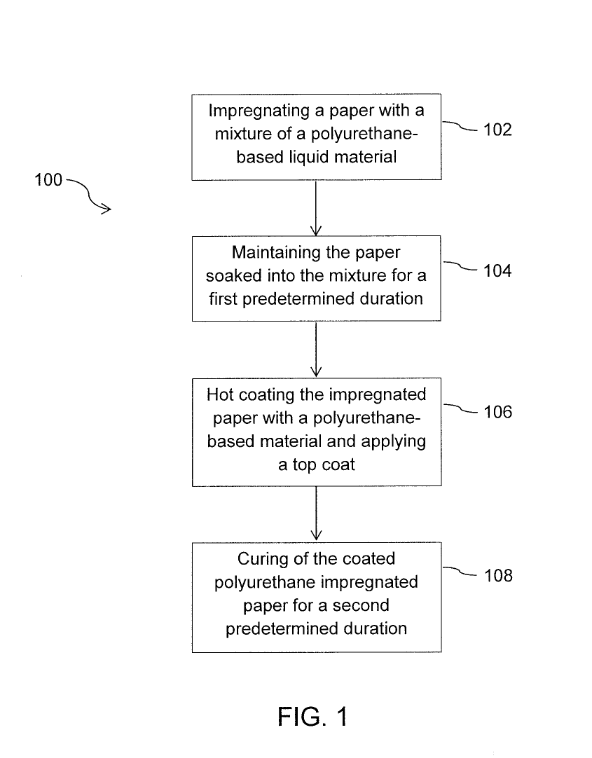

Referring to FIG. 1, there is shown a flow diagram of the polyurethane impregnated paper laminate production process 100 in accordance with an illustrative embodiment of the present disclosure. Steps of the process 100 are indicated by blocks 102 to 108.

The process 100 starts at block 102 where a paper is impregnated with a mixture of a polyurethane-based liquid material (for example impregnation agent VP9461/3 from KLEIBERIT™ Adhesives or the like), typically at an amount between about 20 gr/m² and about 50 gr/m², advantageously between about 34 gr/m²±5 gr/m², and a catalyst (for example 9359/44 from KLEIBERIT™ Adhesives or the like) at an amount between about 5 gr/kg (of paper) and about 15 gr/kg, advantageously between about 11 gr/kg±2 gr/kg.

Optionally, some coloring or dying agent may be added to the polyurethane-based liquid material to adjust the color of the impregnated paper.

Then, at block 104, the paper is maintained, typically enrolled, soaked into the mixture for a predetermined duration, typically between about 12 hours and about 20 hours, and typically within a humidity controlled environment of typically at least 30% RH, and advantageously between about 50% RH (relative humidity) and about 60% RH, for polymerisation of the impregnated paper.

At block 106, the impregnated paper is coated with a sheet (or veneer) of solid polyurethane-based material by hot coating it with a hot coat material such as, for example, the PUR™ 717.0 from KLEIBERIT™ Adhesives or the like with hot melt application, typically at an amount between about 30 gr/m² and about 60 gr/m², advantageously between about 45 gr/m²±5 gr/m², and applying a finishing top coat such as, for example, a UV top coat 817.2 from KLEIBERIT™ Adhesives or the like being hardened or cured via ultraviolet (UV) rays, typically at an amount between about 30 mL/m² and about 60 mL/m², advantageously between about 42 mL/m²±5 mL/m².

Optionally, another coloring or dying agent may be added to the finishing top coat to adjust the color and/or the polyurethane impregnated paper laminate may be embossed to provide texture or designs. Embossing may be executed using an embossing roller.

Finally, at block 108, the hot coated polyurethane impregnated paper laminate is cured for a second predetermined duration, typically about 48 hours and more, advantageously about 72 hours and more, and typically within a humidity controlled environment of typically at least 30% RH, and advantageously between about 50% RH and about 60% RH.

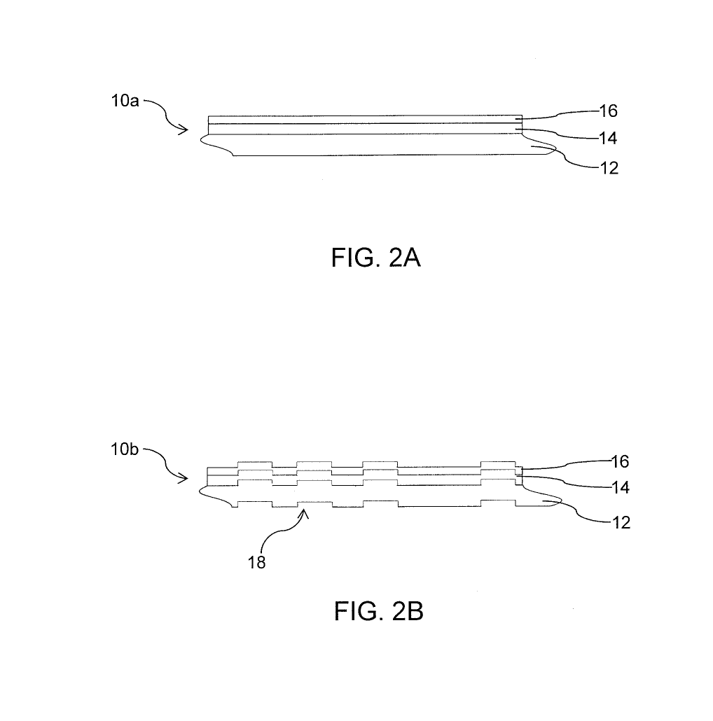

Referring to FIGS. 2a and 2b, there are shown cross-sectional schematic representations (i.e. not to scale) of polyurethane-impregnated paper laminates 10a (without embossing) and 10b (with embossing) produced by process 100 (see FIG. 1). Both polyurethane-impregnated paper laminates 10a, 10b are composed of a base layer 12 in the form of a paper impregnated with a mixture of a polyurethane-based liquid material and a catalyst, a middle layer 14 in the form of hardened sheet of polyurethane-based material and a top layer 16 in the form of a top coat, all of which are described in process 100, while polyurethane-impregnated paper laminate 10b also includes embossing 18.

Although the method of the present disclosure could be performed on generally flat sheets of paper, it is typically performed via a continuous process in series using successive roller-type machines to produce the polyurethane impregnated paper laminate, using rolled paper and rolled polyurethane-based material, being dipped, soaked and bonded (via hot melt coating), coated and optionally embossed via an embossing roller.

Although the present disclosure has been described with a certain degree of particularity, it is to be understood that the disclosure has been made by way of example only and that the present disclosure is not limited to the features of the embodiments described and illustrated herein, but includes all variations and modifications within the scope and spirit of the disclosure as hereinabove described and hereinafter claimed.

I claim:

1. A method for producing a polyurethane-impregnated paper laminate, said method comprising the steps of:
a) impregnating paper with a mixture of a polyurethane-based liquid material and a catalyst;
b) maintaining the paper into said mixture for a first predetermined duration for polymerisation thereof; and
c) hot coating the impregnated paper with a polyurethane-based material and applying a finishing top coat.

2. A method in accordance with claim 1, wherein in step a) said mixture includes an amount of polyurethane-based liquid material between 20 gr/m² and 50 gr/m².

3. A method in accordance with claim 1, wherein in step a) said mixture includes an amount of polyurethane-based liquid material between 29 gr/m² and 39 gr/m².

4. A method in accordance with claim 1, wherein in step a) said mixture includes an amount of catalyst between 5 gr/(kg of paper) and 15 gr/(kg of paper).

5. A method in accordance with claim 1, wherein in step a) said mixture includes an amount of catalyst between 9 gr/(kg of paper) and 13 gr/(kg of paper).

6. A method in accordance with claim 1, wherein step a) further includes adding a coloring or dying agent to said mixture for adjusting the color.

7. A method in accordance with claim 1, wherein in step b) said impregnated paper is maintained enrolled in said mixture.

8. A method in accordance with claim 1, wherein said first predetermined duration is between 12 hours and 20 hours.

9. A method in accordance with claim 1, wherein in step b) said impregnated paper is maintained in said mixture within a humidity controlled environment of at least 30% RH

10. A method in accordance with claim 1, wherein in step b) said impregnated paper is maintained in said mixture within a humidity controlled environment of between 50% RH and 60% RH,

11. A method in accordance with claim 1, wherein in step c) said polyurethane-based material is of an amount between 30 gr/m² and 60 gr/m².

12. A method in accordance with claim 1, wherein in step c) said polyurethane-based material is of an amount between 40 gr/m² and 50 gr/m².

13. A method in accordance with claim 1, wherein in step c) said top coat is cured or hardened via UV rays.

14. A method in accordance with claim 13, wherein in step c) said top coat is cured or hardened via UV rays in an amount between 30 mL/m² and 60 mL/m².

15. A method in accordance with claim 13, wherein in step c) said top coat is cured or hardened via UV rays in an amount between 37 mL/m² and 47 mL/m².

16. A method in accordance with claim 1, wherein step c) further includes adding a coloring or dying agent to said top coat for adjusting the color.

17. A method in accordance with claim 1, wherein step c) further includes embossing said coated polyurethane impregnated paper.

18. A method in accordance with claim 1, further comprising the step of:
d) curing of the coated polyurethane impregnated paper for a second predetermined duration.

19. A method in accordance with claim 18, wherein said second predetermined duration is at least 48 hours.

20. A method in accordance with claim 18, wherein said second predetermined duration is at least 72 hours.

21. A method in accordance with claim 18, wherein in step d) said coated polyurethane impregnated paper is cured within a humidity controlled environment of at least 30% RH.

22. A method in accordance with claim 18, wherein in step d) said coated polyurethane impregnated paper is cured within a humidity controlled environment of between 50% RH and 60% RH.

23. A polyurethane impregnated paper laminate produced by the method of claim 1.

24. A polyurethane impregnated paper laminate comprising a paper impregnated with a mixture of a polyurethane-based liquid material and a catalyst, a sheet of solid polyurethane-based material and a finishing top coat.
